(19) United States
(12) Patent Application Publication
(10) Pub. No.: US 2026/0124116 A1
(43) Pub. Date: May 7, 2026

(54) DOSING OF POWDERED OR GRANULAR SUBSTANCES

(71) Applicant: Abbatialabs SA, Payerne (CH)

(72) Inventors: Thierry Jomini, Payerne (CH); William Bovy, Savigny (CH); Johannes Van Den Anker, Rotterdam (NL)

(73) Assignee: Abbatialabs SA, Payerne (CH)

(21) Appl. No.: 19/114,387

(22) PCT Filed: Oct. 2, 2023
(86) PCT No.: PCT/IB2023/059858

§ 371 Date: Mar. 21, 2025

(30) Foreign Application Priority Data
Oct. 3, 2022 (CH) CH001151/2022

(51) Int. Cl. A61J 7/00

(52) U.S. Cl. CPC A61J 7/0076

(57) ABSTRACT

A dosing device with a dosing mechanism and a dispensing mechanism for providing a metered amount of a powdered or granular substance. The dosing mechanism has a reservoir (2), a rotatable central axis (5) to which a rotatable actuator (3) and a rotatable member (65) metering a volume of the powdered or granular substance to be dispensed is rotationally fixed, at least one dosing chamber (6). The rotatable actuator (3) drives the rotation of the central axis (5) and the rotatable member (65) in at least one rotational direction. The dosing chamber (6) can take a fill state and a release state, which is defined by its angular position. The dispensing device may comprise a dispensing mechanism with a rotatable metering disc (65) having one or more dosing chambers (6).

### TECHNICAL DOMAIN

The present disclosure concerns a mechanism for providing accurate dosing of powdered or granular substances, such as granules or mini tablets used in medical devices for dosing medicinal substances.

### RELATED ART

Accurate dosage of medication is crucial to a successful treatment outcome. Errors in dosage can cause undesired, often severe, side effect for the patient, an increase in bacterial drug resistance, and/or a lack of therapeutic efficacy.

In some patient groups, in particular paediatric patients, the dose of the medicament needs to be adjusted to the body weight and/or the age of the patient. Rather than providing medication in tablet form with predefined amount of the active medicinal component, powdered or granular medicines are preferably provided for oral treatment instead. This formulation offers better flexibility in terms of dose adjustment to the individual patient.

However, obtaining an accurate dose of the powdered or granular medicine remains a significant challenge, in particular when the medicine is prepared and administered outside a hospital setting. This is generally the case for paediatric or geriatric patients, who have difficulties swallowing medication in tablet form. A caretaker of these patient usually prepares the prescribed dose of the granular of powdered medicine freshly in advance of each administration. The prepared dose of medicine is then commonly dissolved in a liquid or in suitable food, such as yoghurt, to ease swallowing the substance.

The provision of a reliable dosing and dispensing device which is sufficiently accurate for dosing powdered or granular medication remains a significant challenge today.

Conventionally, granular of powdered medicines can be measured using a measuring spoon. This is however associated with significant drawbacks such as reduced accuracy, a high risk of contamination due to a repeated opening of the container of the medicine, as well as the repeated use of the dosing spoon, which needs to be cleaned between its different uses. Granular of powdered medicines can also be dissolved into water and then dosed using a measuring syringe. This is however associated with significant drawbacks such as reduced in-use stability, storage in cold controlled environment, as well as adding use steps for the user.

WO2014125396 discloses an integrated dispensing device for a multi-particulate substance comprising a cap, and a dosing head with a slider mechanism controlling the flow path of the substance to be dispensed. The device is an integrated unit adapted to be attached to a container, for example a bottle. To dispense a metered dose, the bottle with the dosing unit must be inverted during the proceed and the actuation of the slider must be coordinated with the inversions of the bottle. Inaccurate dosages due to a lack of coordination between operating the slider and inverting the bottle at the right time during the dispensing process are therefore likely to occur.

It is an objective of the present invention to overcome the disadvantages of the prior art.

### SHORT DISCLOSURE OF THE INVENTION

An aim of the present invention is the provision of a device for dosing and dispensing a medicinal powdered or granular product, which is adapted to provide accurate doses of the medicinal product.

It is a further aim of the present invention that the device is reliable and easy to operate. The device should enable a non-medically trained person to reliably provide a predefined dose of the medication.

It is a yet further aim of the present invention that the risk of contamination of the medicinal product is reduced or eliminated during the operation of the device.

It is yet a further aim of this invention to provide an alternative solution for accurately dosing a medicinal powdered or granular product.

According to the invention, one or more of these aims are attained by the object of the attached claims, and especially by its independent claims. Dependent claims provide further advantageous features of this invention.

In particular, one or more of the aims are attained by a dosing mechanism for providing a metered amount of a powdered or granular substance, comprising a reservoir for containing a powdered or granular substance, a rotatable central axis, such as a central shaft, one or more dosing chambers for temporarily containing the powdered or granular substance, an actuator, which may be configured to perform a rotational or a translational movement in the axial direction of the reservoir.

The term granular substance as used herein also comprises granules, pellets or mini tablets, also referred to as mini-pills, which are commonly administered multiple unit dosage forms.

The dosing mechanism may further comprise a dose selector.

The dosing mechanism further comprises a rotatable member for facilitating dispensing of a metered volume of the powdered or granular substance. The rotatable member may be configured to meter the powdered or granular substance. The rotatable member is rotationally fixed to the central axis.

In an embodiment of this invention the rotatable member is a metering disc comprising one or more dosing chambers of a defined volume.

The dosing of the amount of substance as defined by the dose selector and metered release of the substance are actuated by the rotational or translational movement of the actuator.

A rotational actuation makes it particularly easy to operate a dispensing device with this dosing mechanism.

In an embodiment of this invention, the dose selector is rotatable about the central axis. In this embodiment, the adjustment of the dose as well as the release of the metered amount can be performed with rotational actuation, further enhancing its ease of use. This embodiment is particularly useful if the actuator is a rotatable actuator.

The dosing mechanism is operated without removing any of its component from the reservoir containing the substance to be dispensed. The risk of contamination of the substance in the reservoir remains therefore extremely low.

To protect the content of the device from humidity, in particular during storage, the external openings of the dispensing device, such as an outlet opening through which the powdered or granular product is dispensed, may be temporarily sealed. The seal may be broken or removed prior to using the dispensing device. The seal may for example be provided by a peel foil, such as an aluminium peel foil, which covers the outlet opening of the dispensing device completely.

The dosing chamber has a defined volume, which provides for an accurate dosing of the amount to be released.

The reservoir preferably comprises one or multiple dosage openings through which the substrate contained in the reservoir can exit.

The dosing chamber is rotationally fixed to the rotatable central axis.

The actuator is connected to the central rotational axis, such as to drive the rotational movement of the central axis and the angular displacement of the at least one dosing chamber in at least one of its rotational directions, which is an actionable direction. This actionable direction may be the clockwise direction. It may also be the anti-clockwise direction.

The actuator may be a rotatable actuator which is rotationally coupled to the central axis.

In an embodiment of this invention the actuator is reversibly mounted on the central axis.

The term “reversibly mounted” means that the actuator can take a position in which it is mounted on the central axis such as to engage with it in order to drive its rotational movement, and that the actuator can be removed from this mounted position into a position in which it no longer engages with the central axis, such that the rotational movement of the actuator is no longer coupled to the central axis. The actuator may for example be removed from the central axis by a push force exerted by a biasing member, for example a spring, causing the actuator to glide off the central axis.

An actionable direction is the direction, in which the rotational or translational movement of the actuator is coupled to the rotational movement of the dosing chamber, such as to cause its angular displacement. The actionable direction may be either of the rotational directions, clockwise or anti-clockwise, or even both directions. The actionable direction may be an upwards or downwards translational directions, or even both directions.

In an embodiment of this invention the actuator has only one rotational or translational direction which is actionable, while its rotation or translation in the opposite direction is either uncoupled from the angular displacement of the dosing chamber, or it is blocked.

The at least one dosing chamber may have an inlet aperture for receiving an amount of a powdered of granular substance from the reservoir. The at least one dosing chamber may also have an outlet aperture for releasing the received amount powdered of granular substance. Preferably, inlet and outlet apertures of the dosing chamber are distinct apertures. Preferably, the inlet and outlet apertures are arranged on opposing sides or are opposing sides of the dosing chamber.

The dosing chamber can take a fill state in which it is arranged to be filled, and a release state in which it is arranged to release the substance contained in it. The state of the dosing chamber is defined by its angular position.

Preferably, when the dosing chamber is disposed in its fill state its outlet aperture is sealed. Contrarily, when the dosing chamber is disposed in its release state the outlet aperture is open.

When moving between its fill state and its release state, the dosing chamber passes a position in which it takes an intermediate state, in which the outlet aperture is sealed and the inlet aperture does not open into the portion of the reservoir which is arranged for containing the powdered or granular substance.

The dose selector is configured to cooperate with the actuator. It is preferably disposed between the actuator and the reservoir. By operating the dose selector the amount of the substance to be dispensed is defined.

The dose selector may be configured to define a maximum angular displacement position of the rotatable actuator relative to the reservoir in the actuator's actionable rotational direction, for example the clockwise direction. In this embodiment, the actuator can rotate relative to the reservoir and relative to the dose selector.

The movement of the actuator may be coupled with the rotational movement of the central axis in the actionable direction or the actuator and uncoupled from the rotation of the central axis when moving in the opposite direction. It is however also possible that the movement of the actuator is coupled to the central axis in both of its rotational or translational directions of movement.

The rotatable actuator may for example be rotationally coupled to the central axis in one or in both of its rotational directions.

The dose selector can take different angular positions with respect to the reservoir.

The dose selector is preferably configured to be moved into a set position in which the dose selector is angularly fixed relative to the reservoir. The dose selector is temporarily fixed in this set position. This means that removing the dose selector from a taken set position requires active user intervention.

The set position taken by the dose selector defines a maximum angular displacement position of the rotatable actuator in its actionable rotational directions, for example the clockwise direction.

In an embodiment of this invention, the dosing mechanism comprises a plurality of set positions, into which the dose selector can be moved.

In this embodiment, the angular displacement of the dose selector between two of its neighbouring set positions defines a minimum metered amount of the powdered or granular substance to be dispensed.

For reason of consistency of the minimum metered amount which is dispensed, and to facilitate the metering of the dispensed amount, the set positions should be regularly spaced. As a result, the maximum angular displacement of the actuator corresponds to a multiple of a minimum metered amount which is dispensed.

In an embodiment of this invention the dose selector comprises an annular portion. The annular portion of the dose selector is rotatable relative to the reservoir, respectively relative to a central longitudinal axis of the reservoir.

The annular portion of the dose selector may be arranged about the periphery of the reservoir, preferably at least partially around an end portion of the reservoir.

In an embodiment of this invention the reservoir comprises at least a portion of cylindrical shape. The reservoir may be a cylinder. A cylindrical portion of the reservoir allows for an easy adjustment of the angular position of the dose selector, in particular if the dose selector comprises an annulus which can rotate about a cylindrically shaped reservoir or portion of the reservoir.

The actuator can take a locked position, in which its position in respect of the reservoir is fixed, and it can take an open position, in which the actuator can perform a movement relative to the reservoir. In this embodiment the rotatable actuator takes a locked position, when the angular position of the actuator in respect of the reservoir is fixed. The rotatable actuator takes an open position, in which the actuator can perform a rotational movement relative to the reservoir.

In an embodiment of this invention the actuator, which may be a rotatable button and/or a push button, takes its open position when it is disposed in a proximal position. In this position the rotatable actuator is close to the reservoir and/or the dose selector, for example the annular portion of the dose selector. The actuator may contact the reservoir and/or the dose selector when taking its proximal position.

In this embodiment, the rotatable actuator takes its locked position when it is disposed in a distal position away from the reservoir and/or the dose selector.

It is however also possible that the rotatable actuator takes its locked position when it is in the distal position and takes its open position when it is in its proximal position.

The dosing mechanism may further comprise a biasing member arranged to urge the rotatable actuator away from the reservoir. The biasing member may be a spring, for example a helical spring. The biasing member may also be one or more spring blades. Said spring blades may form part of the dose selector or part of the reservoir.

The spring blades may also force the rotational direction of the dose selector. The spring blades which force the rotational direction of the dose selector may be different from the spring blades pushing the actuator into the distal position. One set of spring blades may be arranged to define the rotational movement of the dose selector, while another set of spring blades may be arranged to push the actuator into its distal position. The direction in which the dose selector can be moved correspond to the actionable direction of the actuator.

In one embodiment, the rotational movement of the actuator is blocked when the actuator takes its depressed, distal position. To unlock the rotatable actuator in its angular position, the rotatable actuator may be moved, for example pressed, towards the reservoir against the force of the biasing member. The open position is maintained, until it is released, for example by no longer actively counteracting the lifting force of the biasing member. It is however also possible, that the actuator is held in its open position by a releasable locking member, maintaining the actuator in its proximal position despite the force of the biasing member. To move the actuator in its distal position, the actuator may be actively disengaged from the locking member.

Preferably, the angular position of the dose selector in respect to the reservoir may be changed when the rotatable actuator takes its locked position.

In an embodiment of this invention, the dose selector can only be moved into a set position when the rotatable actuator is in the locked position, but not when the actuator is in its open position. This prevents that the position of the actuator is inadvertently changes while the dose selector is moved into its set position.

Similarly, the dose selector is preferably rotationally locked in its proximal position, such that the dose setting is not inadvertently modified. The dose selector is preferably urged into the proximal, i.e. its rotationally locked position, by spring blades.

The dose selector is free to perform a rotational movement when it takes its distal position.

The dosing mechanism may comprise a stop member, which is configured to the maximum angular displacement of the actuator when the dose selector takes its set position.

The stop member may be a part of the dose selector. It may also be a separate element, which is attached to the dose selector.

When the stop member is adapted to prevent a further movement of the actuator in at least one of its actionable rotational directions, when contacted by the actuator. The actuator is therefore blocked in its movement in its rotational directions upon abutting the stop member. The stop member is preferably part of or defined by the dose selector.

The angular displacement of the rotatable actuator prescribes the rotational movement of the at least one dosing chamber in respect of the reservoir.

When the dosing chamber is aligned with the dosage opening of the reservoir, the substance can flow through the release cavity. For clarity, the term aligned as used herein does not mean that the edges of the perimeters of the openings have to be superposed. The term “align” or “alignment” of openings or apertures signifies that the openings are superposed on each other such as to form a joint opening through which the powdered or granular substance can pass.

The actuator can drive the rotational movement of the dosing chamber relative to the reservoir to bring it in alignment with the dosage opening of the reservoir. The actuator can also move the dosing chamber out of this alignment position. The flow of substance through the one or more dosing chambers is therefore controlled by the rotational movement of the actuator.

Optionally, the dosage opening of the reservoir may be reversibly sealed. The dosage opening may for example be sealed by a planar, solid sector adjacent to a dosing chamber, which covers the dosage opening when aligned with it. In this embodiment the opening and sealing of the dosage opening can therefore be controlled by the actionable rotation of the actuator.

Through its rotational or translational movement in its actionable direction the actuator can also drive the sequential alignment of a series of dosing chambers and/or sealing solid sectors adjacent to dosing chambers with the dosage opening of the reservoir.

Preferably a plurality of dosage chambers is arranged radially around the central axis. A radial arrangement allows for a sequential alignment of the release cavities with the dosage opening.

The central axis may extend axially through the reservoir.

The actuator and the one or more dosing chambers may be disposed or affixed onto opposite ends or onto opposite end portions of the central axis. It is also possible that the actuator is indirectly connected to the central shaft through an intermediate piece configured to couple the movements of the actuator and the central shaft.

In an embodiment of this invention, the one or more dosing chambers are arranged radially in a metering disc, which is mounted on the central axis in a rotationally fixed manner, such as to rotate together with the central axis.

In an embodiment the metering disc comprises radial sectors, wherein a sector comprising a dosage chamber alternates with a solid planar sector, which does not comprise a dosage chamber. Preferably, the metering disc of this embodiment comprises multiple radial sectors with a dosing chamber. The solid sectors are preferably dimensioned to seal the dosage opening of the reservoir when aligned with it. Upon moving a sector comprising a dosing chamber into alignment with the dosage opening, the dosing chamber can be filled with the substance contained in the reservoir.

The number of radially arranged multiple dosing chambers, which temporarily align with the dosage opening of the reservoir depends on the angular displacement of the rotatable actuator, which prescribes the rotation of the dosing chambers, respectively the metering disc.

Since the set position taken by the dose selector defines the maximum angular displacement of the actuator, which in turn prescribes the number of times a dosing chamber temporarily aligns with the dosage opening of the reservoir, the amount of substrate released from the reservoir depends on the chosen set position into which the dose selector is moved.

To permit for a defined amount to be released to be chosen, the device may comprise appropriate markings. Such markings may for example indicate released substance amounts corresponding to a defined set position, the bodyweight of the patient or a maximum radial displacement of the actuator.

The angular displacement of the dose selector may be defined in minimum angular displacement steps, for example between to neighbouring set positions.

Each minimum angular displacement step of the dose selector preferably corresponds to a fixed amount of released substance, which is the minimum metered amount of the released substance.

In an embodiment of this invention, this minimum metered amount corresponds to the amount of substance which can be held in a completely filled dosing chamber. In embodiments with a plurality of dosing chambers, each dosing chambers should have the same inner volume for temporarily containing the substance.

The angular displacement of the dose selector from a first angular position to a second angular position, preferably from a first set position to a second set position, may be a multiple of its minimum angular displacement step. This multiple of the minimum angular displacement step of the dose selector then prescribes the maximum angular displacement of the actuator.

In this embodiment, the amount of the powdered or granular substance to be dispensed when the actuator is moved to its maximum angular displacement position, is defined by the number of minimum displacement steps between the first and the second angular position of the dose selector.

In so far as each minimum displacement step of the dose selector corresponds to a minimum metered amount, the amount of substance released is a multiple of the minimum metered amount.

The dosing mechanism described herein is preferably combined with a suitable dispensing mechanism in a dosing device.

Examples of a suitable dispensing mechanisms are described in the following paragraphs. One or more of the aims of this invention are attained by the dispensing mechanism.

The dosing mechanism and the dispensing mechanism of claimed in this invention share essential features, such as the reservoir, the central axis, and at least one, preferably a plurality of dosing chambers.

It should however be noted that the dispensing mechanism described herein can also be combined with other devices, which may comprise alternative dosing mechanisms.

The dispensing mechanism for providing a metered amount of a powdered or granular substance claimed by this invention, comprises a reservoir for containing the powdered or granular substance with a dosage opening for releasing the contained powdered or granular substance.

The dispensing mechanism further comprises a rotatable metering disc having at least one, preferably a plurality of dosing chambers for temporarily containing a powdered or granular substance. A plurality of dosing chambers is preferably arranged radially around the centre of the metering disc. Each dosing chamber has an inlet aperture for receiving the powdered or granular substance when aligned with the dosage opening of the reservoir, and an outlet aperture for releasing the received powdered or granular substance.

The dispensing mechanism further comprises a central rotatable axis onto which the metering disc is rotationally fixed. The central rotational movement of the central axis drives the angular displacement of the metering disc. Central axis and metering disc perform their rotational movement together.

The dosing chambers have a defined filling volume for accurate dosing of the substance.

Each dosing chamber can take a fill state in which the outlet aperture is sealed, and a release state in which the outlet aperture is open, the state of the dosing chamber being defined by its angular position relative to the reservoir.

In an embodiment of this invention the metering disc comprises radial sectors, wherein a sector comprising at least one dosing chamber alternates with a solid planar sector, which does not comprise a dosing chamber. Preferably, the alternating radial sectors are of similar or equal dimension. When the metering disc is rotated in respect of the reservoir, the radial sectors align in sequence with the dosage opening of the reservoir.

In an embodiment of this invention each of the plurality of dosing chambers has the same inner volume. As the inner volume of the dosing chamber defines the minimum metered amount of the substance to be dispensed, the total metered amount of the substance which is dispensed by more than one dosing chamber is therefore a multiple of the minimum metered amount.

The solid sectors preferably are dimensioned to seal the dosage opening of the reservoir when aligned with it, such that the substance in the dosing chamber remains contained therein. Moving a sector comprising a dosing chamber into alignment with the dosage opening of the reservoir, allows to fill the dosing chamber with the substance contained in the reservoir.

To fill the dosing chamber its outlet aperture must be sealed. To this end, a controlled release member may be disposed such as to seal the outlet aperture of the dosing chamber when inlet aperture of the dosing chamber is aligned with the dosage opening of the reservoir.

The controlled release member may comprise a planar portion for covering the outlet aperture of one or more dosing chambers.

The controlled release member may further comprise a release aperture dimensioned for releasing the substance contained in the dosing chamber when the release aperture is aligned with the outlet aperture of the dosing chamber, such that the dosing chamber takes its release state.

The volume of the dosing chamber defines the minimum metered amount which can be dispensed by the dispensing mechanism. If a full dosing chamber releases the substance it holds only once, this minimum amount corresponds to the dispensed amount.

The number of times the dosing chamber sequentially releases the substrate contained by it through defines the total dispensed amount. The total dispensed amount is therefore a multiple of the minimum metered amount defined by the inner dimensions of the dosing chamber. For an accurate metering, the dosing chamber must be filled completely before releasing the substance.

Preferably, the rotation of the metering disc causes the dosing chamber to alternatingly take its sealed and its release state, such that the dosing chamber can be replenished with substance through the dosage opening of the reservoir after it has emptied by dispensing the temporarily contained substance through its open outlet aperture.

In a further embodiment, the reservoir may comprise a guiding member, for example a guiding inner wall or a funnel, for directing the powdered or granular substance contained in the reservoir to the dosage opening of the reservoir.

In an alternative embodiment the guiding member may comprise one or more guiding blades for guiding the powdered or granular substance into the one or more dosing chambers. The guiding blades should be arranged in the reservoir to suit this purpose. The guiding blades may for example be straight, curved and/or slanted. They may be arranged radially along the inner volume of the reservoir. They may also be arranged helically in the reservoir.

The one or more guiding blades may be rotatable. In an embodiment they may be actuated through the rotational central axis. The guiding blades are rotationally fixed to the central axis.

The one or more guiding blades may be comprised in or fixed to the rotatable member. The one or more guiding blades may perform their rotational movement together with the dosing chamber.

In one embodiment the guiding blades are comprised in or fixed to the rotatable member and are therefore rotatable about the central axis. In this embodiment the position of the one or more dosing chambers is fixed in respect of the reservoir.

The rotatable blades may be arranged and/or configured to crush the powdered or granular substance. The rotatable blades may also be arranged and/or configured to compress the powdered or granular substance in the dosing chamber.

The rigidity of the material combined with the shape of the blade may be chosen such that they cause crushing and/or compressing of powdered or granulate substances when operated. Suitable materials and shapes for crushing and/or compressing are known in the art.

In a further embodiment, the reservoir may comprise fixed deflectors, for directing the powdered or granular substance contained in the reservoir to the dosage openings of the reservoir.

The dispensing mechanism may further comprise an outlet member for receiving the metered powdered or granular substance released from the dosing chamber, wherein the outlet member is preferably shaped to direct the metered substance towards an outlet opening of the device.

When combined with a dosing mechanism, each minimum dosing step, for example the minimum angular displacement step described above, should comprise the sequential alignment of a solid sector and of a sector comprising the inlet aperture of the dosing chamber, either in this order or in the reverse order, with the dosage opening of the reservoir. This sequential alignment ensures, that the dosing chamber can be refilled after each discharge.

The dosing mechanism and/or the dispensing mechanism are particularly useful for handheld dispensing devices.

In a dispensing device the central axis may extend axially through the reservoir connecting the dosing mechanism, which is mounted on one end portion or on one end of the central axis, with a suitable dispensing mechanism mounted on the opposite end portion or opposite end of the central axis. Preferably, the dispensing mechanism is the mechanism described herein.

In an embodiment of this invention, the rotatable actuator of the dosing mechanism actuates the rotational movement of the central axis and the metering disc when the actuator rotated in its actionable rotational direction, for example in clockwise direction. In this embodiment the rotational movement of the actuator, the central axis and the release disc is preferably blocked when the actuator is pushed in the opposite, second rotational direction, for example the anti-clockwise direction.

The dosing mechanism and dispensing device of this invention are particularly suited for medicinal powdered or granular substances. It is therefore preferably that the dispensing device comprising the dosing and/or dispensing mechanism of this invention is a disposable device, as a refilling of the reservoir once all the substance has been dispensed is not intended. Contaminations of the reservoir and substance contained therein with cleaning agents and/or remaining substance of the previous filling is thereby avoided.

The dosing mechanism and dispensing device require minimum user intervention, no removing of components is required for dosing and/or dispensing the metered amount of substance. No complex coordination actions, such as inverting the device when operating certain components, is required. The described dosing and dispensing mechanisms are therefore extremely reliable.

The invention also concerns a method for dosing and dispensing a metered amount of a powdered or granular substance.

The term “comprises” means “includes” in a non-limiting sense.

The terms “for example” and “such as” are used herein to indicate a non-limiting example.

### SHORT DESCRIPTION OF THE DRAWINGS

Exemplar embodiments of the invention are disclosed in the description and illustrated by the drawings in which:

FIG. 1A is a lateral view of a preferred embodiment of a hand-held dispensing device according to this invention;

FIG. 1B is a longitudinal cross-section long the central axis of the device of FIG. 1A;

FIG. 1C is a perspective view of the longitudinal cross section shown in FIG. 1B;

FIG. 2 is an exploded view of the embodiment of the dispensing device of FIGS. 1A to 1C;

FIG. 3A is a lateral view of the embodiment shown in FIGS. 1A to 1C with the actuator in its blocked, distal position and the dose selector in its set position;

FIG. 3B is a lateral view of the embodiment shown in FIGS. 1A to 1C with the actuator in its blocked, distal position and the dose selector disengaged from its set position for adjustment;

FIG. 3C is a lateral view of the embodiment shown in FIGS. 1A to 1C with the dose selector in its new set position and the actuator in its open, proximal position;

FIG. 4 is another embodiment of a dosing device according to this invention comprising a rotary lifter mechanism;

FIG. 5 is another embodiment of a dosing device according to this invention comprising a secured forth and back mechanism;

FIG. 6 is another embodiment of a dosing device according to this invention comprising a push button mechanism;

FIG. 7 is a three-dimensional view of a longitudinal cross section, which is offset from the central axis, of the lower portion of the embodiment shown in FIG. 1A to C, depicting the dispensing mechanism with a funnel shaped guiding member;

FIGS. 8A and 8B are further embodiments of a dosing device with guiding blades according to this invention, wherein FIG. 8A shows an embodiment with straight guiding blades and FIG. 8B shows an embodiment with curved guiding blades.

### EXAMPLES OF EMBODIMENTS OF THE PRESENT INVENTION

A dispensing device according to this invention comprises an actuator 3, which may be rotatable, for driving the rotational movement of a rotatable member 65 through a central axis 5.

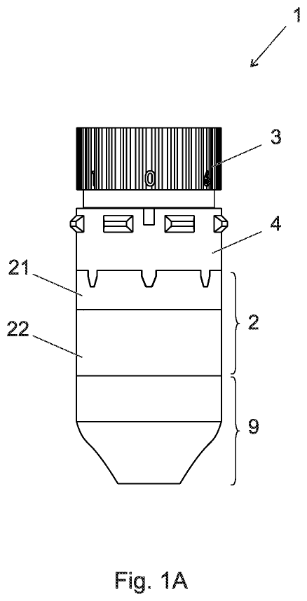

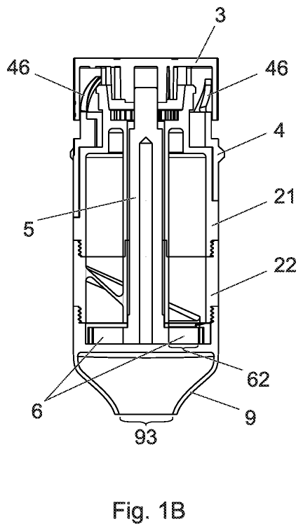

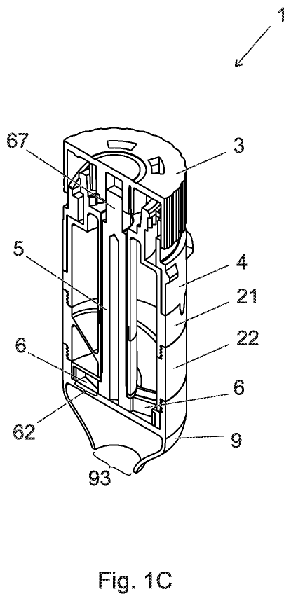

A preferred embodiment of a dispensing device 1 for powdered or granular substances comprising a dose selector 4 is shown in FIG. 1A, which is a lateral view of the device, and well as in FIGS. 1B and 1C, depicting a longitudinal cross-section of the device along its central axis 5. The central axis 5 shown in this embodiment is a central shaft with a hollow core.

The embodiment depicted in FIGS. 1A to 3C and in FIG. 9 shows one possible example of a handheld dispensing device according to this invention. It comprises a dosing mechanism and a dispensing mechanism, which are described in detail below.

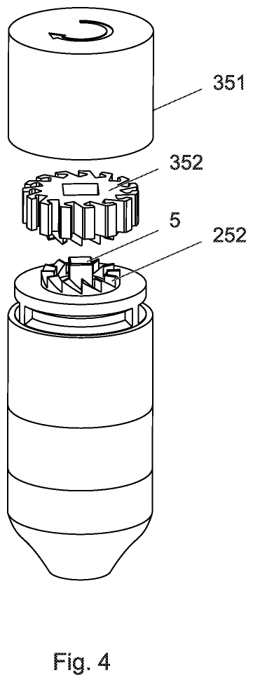

Alternative embodiments of the dosing mechanism, for example the embodiments shown in FIGS. 4 to 8 may be chosen and/or combined with different dispensing mechanisms, for example dispensing mechanisms depicted in FIGS. 9 and 10, according to this invention. This invention is not particularly limited to any specific combination of a dosing mechanism and a dispensing mechanism of the invention.

The dispensing device of this invention comprises a dosing mechanism disposed in one end portion of the device and a dispensing mechanism disposed on the opposite end portion of the device. A reservoir 2 containing on the powdered or granular substance to be dispensed is interposed between essential components of the dosing mechanism, including a actuator 3, which may be rotatable, and a dose selector 4 and components of the dispensing mechanism, for example a metering disc 65 with a plurality of dosing chambers 6.

Components of the dosing mechanism and components of the dispensing mechanism are connected through a central rotatable axis 5, which extends the length of the reservoir.

The dispensing device 1 of this invention is preferably handheld device. The overall shape of the device, as defined by the shape of the reservoir is substantially cylindrical. A cylindrical shape is particular ergonomic for the handling of the device, as the selection of the dose as well as the dispensing of the substance is achieved by rotating the dose selector respectively the actuator about a common central axis relative to the reservoir. The reservoir is however not limited to a cylindrical shape. If the reservoir has a different shape, it has preferably cylindrical portions arranged to facilitate the rotational movements of the actuator, dose selector and/or metering disc.

The embodiment shown in FIGS. 1A, 1B and 1C comprises a dosing mechanism with a rotatable actuator 3 and a dose selector 4. The dosing mechanism is connected to the dispensing mechanism by the central axis 5. In the embodiment shown, the rotatable member 65 is a metering disc with a plurality of dosing chambers 6.

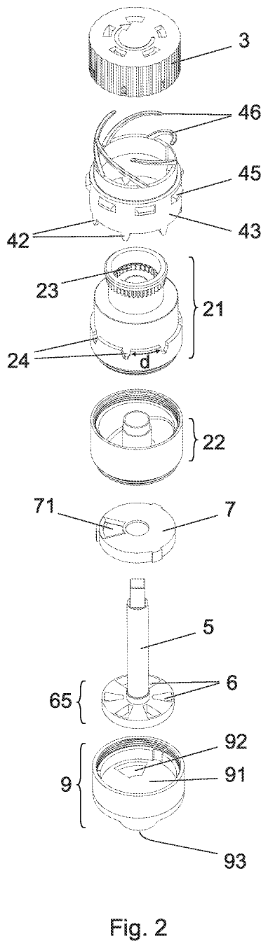

The metering disc 65 with the dosing chambers 6 is rotationally fixed on one end of the central axis 5, as is shown in FIG. 2, which is an exploded view of the embodiment of FIGS. 1A and 1B. The rotatable actuator 3 is mounted on to the opposite end to the central axis 5, such as to drive the rotation of the axis and by extension also the metering disc 65, respectively the dosing chambers 6.

The actuator 3 is preferably a rotatable knob or button.

The actuator 3 can take a locked position, in which its rotational movement is blocked, and an open position, in which it can be rotated.

In the embodiment of the dosing mechanism of the depicted device, the actuator 3 is pushed in the opposite direction of the reservoir by a biasing member, in the shown example spring blades 46 of the dose selector 4. This position is a distal position in respect of the reservoir. When in this position, the actuator 3 is in its blocked position.

The rotational movement of the actuator 3 can for example be blocked by a structural feature of the reservoir 2 cooperating with a structural feature of the actuator in its locked position, such as to prevent its angular displacement. Such a blocking structural feature of the reservoir 2 may for example be a dentition 23 engaging with a corresponding structural feature, for example a matching protrusion or a matching dentition of the actuator 3 (not shown).

When moved into its open position, the blocking structural feature 23 of the reservoir is disengaged from the corresponding feature of the actuator 3, such that the actuator is free to perform a rotational movement. In the depicted example of the dosing mechanism the actuator 3 takes its open position when pressed towards the reservoir 2 against the force of the biasing member, in this case the spring blades 46.

The angular position of the dose selector 4 in respect of the reservoir can preferably only adjusted when the actuator is in its locked position. It is therefore prevented, that the actuator 3 slips, respectively changes its angular position, while the position of the dose selector 4 is adjusted.

The dose selector 4 can be temporarily fixed in a stable set position. Preferably the dose selector can be moved into a series of sequential set positions.

In order to provide accurate and reproducible doses of dispensed substance, the distance d between each pair of adjacent set positions is the same. The angular sector included by two adjacent set position has the same dimensions for each pair of adjacent set positions. In other words, the set positions are distributed regularly around the periphery of a portion of the reservoir with a circular cross section.

The angular displacement of the doe selector 4 between each pair of two adjacent set position is therefore the same. This angular displacement between two set positions corresponds to a minimum angular displacement step of the dose selector 4.

In the embodiment shown in FIG. 2, the dose selector 4 has an annual central portion 43 which is arranged around the periphery of the cylindrical reservoir, or a cylindrical portion of the reservoir. The annular shape is particular advantageous, since it can be easily rotated by the user. To further enhance the ease of handling, the annular portion 43 may be equipped with gripping features 45, for example radial protrusion, which may be regularly distributed around the annulus, such as to provide a better grip and prevent the user's fingers from slipping when adjusting the dose selector.

Alternatively or additionally, the annular portion 43 may comprise other features enhancing a user's grip, such as an adequate surface texture or structure, or a non-slippery material, or other features known in the art. The annular portion may comprise a combination of features to improve the grip.

The dose selector 4 of this example further comprises the biasing member 46, in this case spring blades 46. It is however also possible to provide a separate biasing member, for example a helical spring, pushing the actuator 3 away from the reservoir 2 and from the dose selector 4.

To stabilise the dose selector 3 in its set position, setting members, 42, which may be axial protrusions, are arranged along the rim of the central annulus portion 43 to guide the dose selector into a set position. The axial protrusions 52 are dimensioned to cooperate with corresponding grooves 24 around the periphery of the reservoir, which define the sequential set positions.

The regularly spaced set position may be indexed, for example with markings indicating relative amounts to be dispensed when the dose selector is moved between two adjacent set positions.

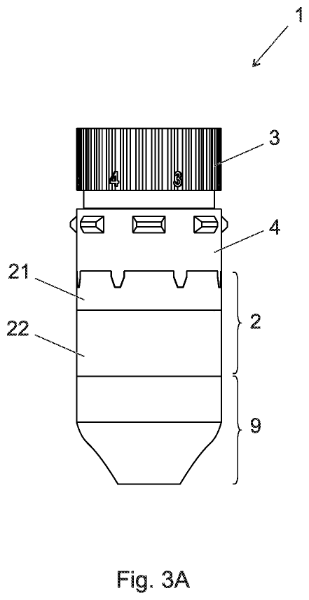

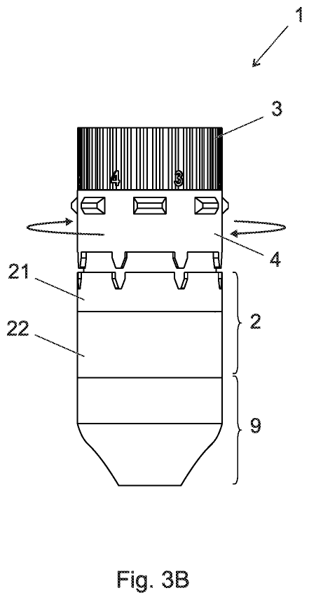

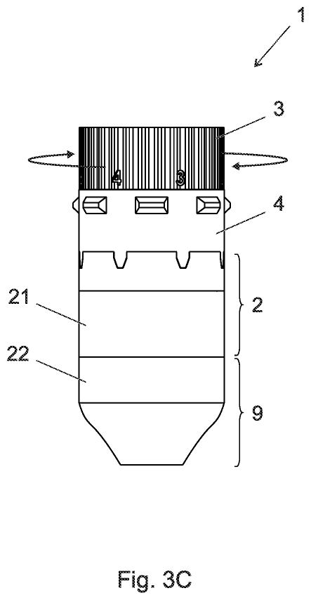

FIGS. 3A to 3C depict the different positions taken by the actuator 3 and the dose selector when operating the dosing mechanism.

In FIG. 3A the actuator 3 is in its distal position, which is its locked position. In this position the rotational movement of the actuator is blocked. The dose selector shown in this figure is in a stable set position.

To define the maximum angular displacement of the actuator, which drives the rotational movement of the dosing chamber 6, the dose selector is moved out of its set position, in this case lifted upwardly, as is shown in FIG. 3B. In this Figure the actuator is still in its locked position, while the dose selector can be angularly displaced in relation to the locked actuator and the reservoir.

The dose selector 4 can now be moved into a new set position. In an embodiment here the set positions are regularly spaced, the distance between one set position to an adjacent set position corresponds to one displacement step. Each step corresponds to a metered minimum amount of substance to be dispensed. The desired total amount of substance to be dispensed can therefore be chosen by the number of steps between a first set position taken by the dose selector and a second subsequent set position into which the dose selector is moved.

In FIG. 3C the dose selector 4 has been moved into a second set position and the actuator is now urged against the biasing force of the spring blades 46 into its open position. In this position the actuator 3 can be rotated in an actionable direction, i.e. in a direction in which it is rotationally coupled to the central axis 5, until it is blocked by a structural element of the dose selector, for example a stop member, blocking the further displacement of the actuator in this direction. The position of the blocking structural feature in respect of the reservoir is defined by the set position taken by the dose selector 4.

The stop member may for example comprise a sectional protrusion on the inner diameter of the dose selector 4 and of a sectional protrusion of the actuator 3 (not shown). By rotating the dose selector 4, an angular distance between both protrusions may be created. When subsequently rotating the actuator 3 in the same rotational direction as the dose selector 4, this angular distance is reduced until the two protrusions contact each other. Since the dose selector 4 is fixed in its angular position when the actuator 3 is rotated, the protrusion of the dose selector prevents the actuator 3 from continuing its rotational movement when the protrusions of dose selector and actuator contact each other. The actuator is therefore stopped from rotating further.

As mentioned above, different embodiments of this invention may be provided with the dispensing device.

In a possible variation of the embodiment of FIGS. 1a to 3C no dentition 23 is provided for blocking the rotatable actuator 3 in its locked position in small incremental steps as described above. Instead, the dentition 23 shown in FIG. 2 may be replaced by one large structural protrusion of the reservoir engaging with a corresponding structural feature of the actuator, such that the actuator can only locked in positions at a defined angular distance, but not between said positions. Preferably, this defined angular distance corresponds to a minimum metered amount of the substance, which is defined by the size of the dosing chamber 6. This variation prevents dosing errors due to incomplete turning of the actuator 3 through the set angular distance. The actuator can only be blocked after completing the rotation corresponding to one or more whole minimum metered amounts. In other words, by replacing the small incremental blocking positions with stepped blocking positions, each corresponding to a minimum metered amount, no fractions of minimum metered amounts are dispensed. The accuracy of dosage is thereby improved. Possible incorrect handling, in particular by the untrained user, is reduced. The device is therefore more reliable.

It is also possible to provide a dispensing device of this invention comprising a dosing mechanism without the dose selector. Different possible embodiments are shown in FIGS. 4 to 6.

FIG. 4 depicts an embodiment of a rotatable actuator 3 comprising a rotatable, cylindrical cap 351 and an intermediate gear wheel 352, which engages with a dentition 353 radially protruding inwards form the side walls of the cylindrical cap.

The cylindrical cap 351 can be turned in two rotative direction, one of which is the actionable direction. It engages with the intermediate gear wheel such that the gear wheel 352 is only driven by when the cylindrical cap is rotated in the actionable direction, but not when it is rotated in the opposite direction. The gear wheel 352 is mounted on the central axis 5. It drives the rotation of the axis and thereby the rotation of the rotatable member, for example a metering disc 65 as shown in FIG. 2. The dented support structure 252 which is arranged around the central axis engaged with the gear wheel 352 to ensure that the gear wheel rotates only in the actionable direction by preventing rotation in the opposite direction. The simplicity of this design renders it easy to manufacture, economical and readily applicable.

Another possible embodiment of the dosing mechanism without a dose selector 4 (not shown) comprises a rotatable, cylindrical actuator 3 which remains mounted on the central axis 5 during the use of the device. The side wall of the actuator 5 comprises an inwardly bulging projection. The dosing mechanism further comprises at least two stop members, which are fixed in relation to the reservoir, and which define the maximum rotational distance of the actuator by preventing a further movement of the actuator when its inward projection abuts one of the stop members. The actuator can perform back and forth rotational movements between the positions defined by the stop members.

For improved haptic and/or acoustic detection of the rotational movement, a toothed rack may be provided between the stop members. The projection contacts the toothed rack while passing thereby providing haptic and acoustic feedback regarding the rotation to the user. The tooth rack may comprise larger end teeth, which inform the user of the end position of the actuator by emitting a stronger haptic of acoustic feedback.

In this embodiment the movement of the actuator in either of its rotational directions drives the rotation of the central axis which is directly connected to the actuator.

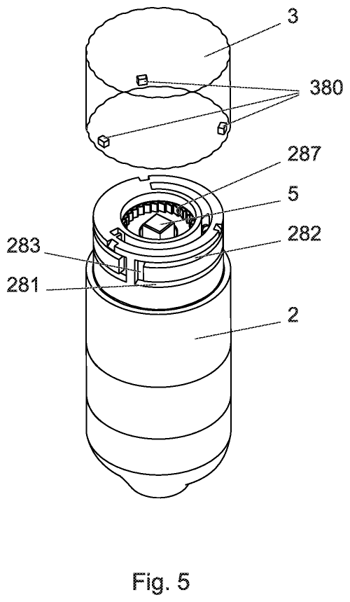

In an further embodiment depicted in FIG. 5, only one of the rotational directions of the actuator 3 drives the rotation of the central axis 5. The sidewall of the actuator 3 has inwardly bulging projections 380 which engage with a closed guide groove comprising a lower groove 281 and an upper groove 282 which are connected through side groove 283. The actuator in FIG. 5 is depicted with transparent walls to show the inwardly bulging projections 380. In the depicted example the guide groove takes defines a rectangular shape. It my however also take another shape, for example a trapezoid or a rhomboid shape. In its resting position the actuator 3 is urged upwardly by a biasing member (not shown), which may be a spring blade or, as shown here, a helical spring. When the actuator 3 is pushed towards the reservoir 2 the projection 380 its moves downwards along a side prove 283 until it reaches the lower groove 281. In this position the actuator 3 engages with the central axis 5. The lower groove 281 guides the projection 380 and thereby the rotational movement of the actuator in one direction, which is the actionable direction. To prevent a backwards movement of the actuator while in the lowered position the device may be provided with a dentition 287 which prevents a backwards rotational movement of the actuator 3. While in its lowered position, the actuator 3 may therefore only be rotated in one direction, which is its actionable direction.

When the projection 380 reaches a side groove 283, the actuator 3 is urged upwards by the biasing member (not shown) and the projection 380 is moved upwardly into the upper groove 282. In this relaxed or resting position, the actuator 3 is removed from the central axis 5 and disengaged from the dentition 287. It can therefore be moved back and forth along the upper groove 282 without actuating the central axis 5 of the device. In one embodiment the actuator may be urged along the upper channel in the opposite direction of the actionable direction. For this purpose, further biasing members may be provided (not shown). In this embodiment the actuator 3 is automatically pushed into a position in which it can be operated for providing further doses of the substance to be dispensed.

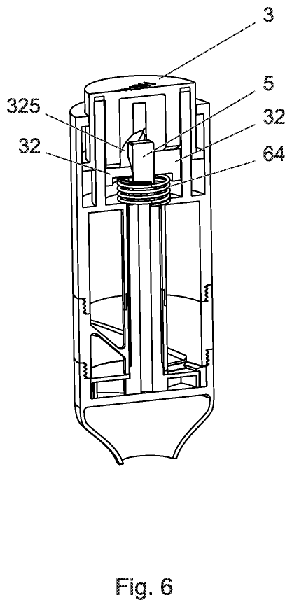

A further possible embodiment of the dosing mechanism is shown in FIG. 6. This embodiment relies on a push button as an actuator 3. The actuator 3 is urged downwards against the force of a biasing member 64, thereby pushing an intermediate rotatable member 32 downwards. The intermediate rotatable member engages with the rotatable central axis 5 of the device to drive its rotational movement.

The actuator 3 and the intermediate rotatable member 32 each have oblique planes arranged to compatibly contact each other. The rotational movement of the intermediate member 32 is driven by the up and downward movement of the actuator 3 and the biasing force of the biasing member 64 urging the intermediate member 32 upwardly. When pressed downwardly, the oblique plane 325 of the intermediate member 32, pushed upwardly by the biasing member 64, glides upwardly along the oblique plane of the actuator 3. Once the actuator is released and pushed upwardly, the intermediate member 32 completes its rotational movement until the oblique plane 325 until it abuts at a structural obstacle.

The actuator 3 of this embodiment is therefore not rotatable itself, but it drives the rotational movement of the intermediate member 32, which itself is rotationally coupled to the central axis 5.

Pressing the actuator 3 from its relaxed to its maximally compressed position, results in the dispensing of one defined metered amount of the powdered or granular substance.

The different embodiments or variations thereof may be provided as suitable dosing mechanisms in a dispensing device according to this invention.

The reservoir 2 of the dispensing device may be a single piece. However, as is shown in FIG. 2, the reservoir may comprise two distinct parts, a first part 21 cooperating with the dosing mechanism and a second part 22 cooperating with the dispensing mechanism, which may be joined to contain the substance to be dispensed as is shown in the depicted example. Providing the reservoir in two parts renders the production of the device easier, as the portions cooperating with components of either the dosing mechanism or the dispensing mechanism are produced and fitted to these components separately. In addition, the reservoir can be filled more easily.

When used for medicinal substances, the reservoir of the device is however not intended to be refilled. A refillable device would pose the risk of contamination of the substance with a substance from the previous filling or with cleaning agents.

For this reason, it is preferably, that dosing and dispensing mechanisms are permanent components of the device. Components of these mechanisms should be integral parts of the device. They should be fixedly attached such as to prevent their removal from the device.

As shown in FIG. 2 the actuator 3 of the dosing mechanism is linked to the metering disc 65 of the dispensing mechanism through the central rotatable axis 5.

The actuator 3, the central axis and the metering disc 65 perform their rotational movements synchronously when the actuator rotates in its actionable direction.

In an embodiment of this invention the rotatable central axis 5 extends through the reservoir, wherein the metering disc 65 and the actuator 3 are attached to opposite ends or end portions of the central axis 5. When operating the device, the device should be in a substantially upright position. In this position the actuator 3 should be disposed at the upwards facing end of the device while the metering disc 65 should be disposed in a lower portion of the device. The flow of the substance contained in the reservoir can therefore be driven towards the dosage opening 25 by gravitational force.

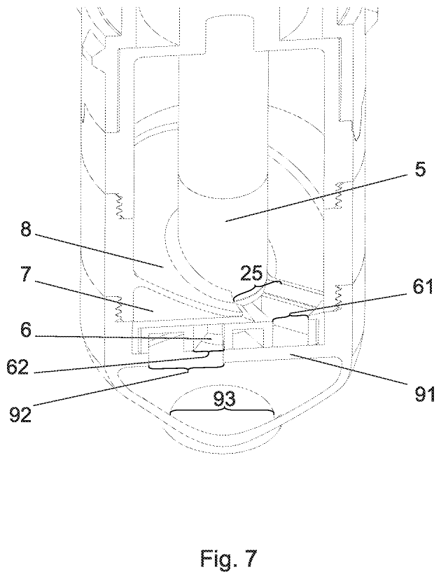

To guide the substance towards the dosage opening, the reservoir may comprise one or more guiding members 8, such as ridges, a funnel-shaped wall, or a wall or floor sloping off towards the dosage opening 25, as shown in FIG. 7. The guiding member facilitates the speedy and efficient filling of a dosing chamber 6 when the chamber is aligned with the dosage opening 25.

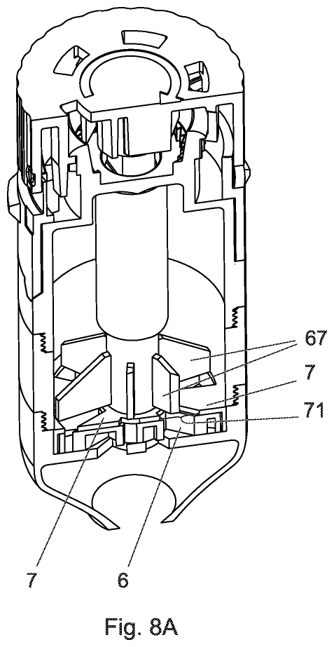

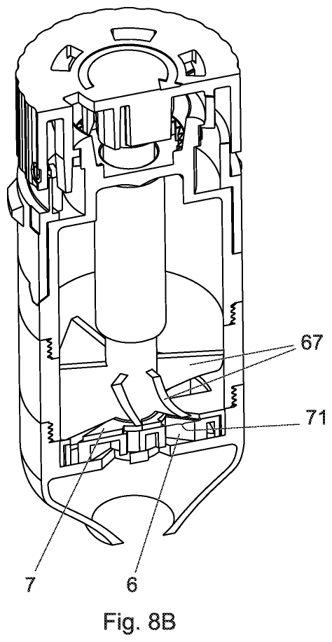

In an alternative embodiment, the rotatable member comprises a metering disc 65 as well as guiding blades 67 as shown in FIGS. 8A and 8B. A levelling disc 7 is interposed between the metering disc and the guiding blades 67. The levelling disc 7 comprises one or more levelling apertures 71 which can connect with the inlet apertures of the one or more dosing chambers 6 comprised in the metering disc 65 such as to enable the flow of the powdered or granular substance from the reservoir into the dosing chamber 6. The guiding blades are arranged such that upon their rotation they push the powdered or granular substance disposed on the levelling disc towards the levelling aperture 71. The substance is pushed through the superposed levelling aperture 71 and an inlet aperture 61 of the dosing chamber 6.

FIG. 8A shows an embodiment with straight guiding blades. The curved guiding blades shown in FIG. 8B are particularly suited for compressing the granular or powdered substance in the dosing chamber 6.

The dosing chamber 6 has an inlet aperture 61 facing the reservoir and an outlet aperture 6 opposite the inlet aperture. When the outlet aperture 62 is sealed, the dosing chamber 6 takes is fill state, in which it can either be filled with substance through the dosage opening 25 or contain the substance it received.

When the outlet aperture 92 is not sealed, the dosing chamber is in its release state.

The outlet aperture 62 of the dosing chamber 6 may be sealed by a solid planar portion 91 of a release member.

The release member may also comprise an outlet opening 92, through which the metered substance contained in the dosing chamber 6 can pass, when the outlet opening 92 of the release member and the outlet aperture 62 of the dosing chamber 6 are superposed on each other. The dosing chamber is in its release state when its outlet aperture 62 is opens into the outlet opening 92 of the release member.

To functionally alternate the fill and release state of the dosing chamber 6, its outlet opening 92 of the release member should preferably positioned in the device, such that it aligns with the dosing chamber 6 after the dosing chamber 6 aligned with the dosage opening 25 of the reservoir. In other words, the dosing chamber 6 should align in a first position with the dosage opening 25 of the reservoir and in a second position with the release aperture 92. The movement from the first to the second position is driven by the rotational movement of the central axis 5.

When moved between the first and the second positions, the dosing chamber passes through an intermediate position, in which both openings of the dosing chamber 6, i.e. its inlet aperture 61 and its outlet aperture 62 are covered or sealed. In this position the inlet aperture is preferably covered or sealed by the levelling disc 7 and the outlet opening is preferably covered or sealed by the planar portion of the release member 91.

In this embodiment, the rotational movement of the central axis 5 displaces the dosing chamber 6 from its alignment position with the dosage opening 25 to its alignment with the outlet aperture 92.

The dispensing mechanism may further comprise a levelling disc interposed between the reservoir and the metering disc. The levelling disc serves to smooth the surface of the substance filled into the dosing chamber 6. It may also serves to seal the inlet aperture once the dosing chamber is filled.

As shown in FIGS. 2 and 4, the levelling disc 7 comprises an aperture 71 which superposes the dosage opening 25 and which is dimensioned to provide a unencumbered passage of for the substance contained in the reservoir to the dosing chamber 6, when the dosing chamber is aligned with the dosage opening 25.

The angular position of the levelling disc may be fixed relative to the reservoir.

In an alternative possible embodiment, the angular position of the levelling disc may be altered, such that the solid portion of the disc may seal the dosage opening. By providing a rotatable levelling disc an additional locking function for interrupting the flow of the substance from the reservoir is provided.

It is however also possible to provide this additional function with alternative locking members, for example a slider, adapted to reversibly seal the dosage opening 25 of the reservoir.

In an embodiment of this invention, the dosing chambers 6 are equally dimensioned and are arranged in radial sectors of the metering disc 65. Preferably, each sector containing a dosing chamber 6 is flanked with two solid sectors. These solid sectors are preferably planar and do not comprise any openings or apertures through which the powdered or granular substance can pass. In other words, the solid sectors are arranged between two sectors comprising a dosing chamber 6 each, as is depicted in FIG. 2.

Upon rotation of the central axis 5 the alignment with the dosage opening 25 of a sector comprising a dosing chamber 6 and a solid sector alternate.

When a dosing chamber 6 is aligned with the dosage opening 25, it should be in its fill state, such as to be suited to receive and to temporarily contain the substance to be dispensed. Once it is filled, the metering disc 65 is rotated. The rotational movement of the metering disc is driven by the central axis 5. As a result a solid section of the metering disc 65 interrupts the flow of the substance from the reservoir.

As a result of a rotation of the metering disc 65 subsequent to the filling of the dosing chamber 6, the outlet aperture 62 is brought into alignment with the release aperture 92, such that the metered dose of the substance temporarily contained in the dosing chamber 6, is released though the release aperture 92.

The dispensing mechanism may comprise an outlet member 9 with an outlet opening 92. The outlet member serves to guide the metered amount of the substance to be dispensed towards the outlet opening 92, which should be suitably dimensioned for the intended purpose of the posing device and/or the physical properties of the powdered or granular substance to be dispensed. For example, an opening 91, which may be a nozzle, with a smaller diameter may be better suited for releasing fine powders than for larger particles.

The dosing and dispensing device 1, which is preferably a handheld device, can be used to dispensed a metered amount of a powdered or granular substance by following the procedure below.

A powdered or granular substance to be dispensed, preferably a medicinal product, is provided in the reservoir of a device comprising dosing mechanism described above, as well as a dispensing mechanism comprising a metering disc 65 with at least one, preferably a plurality of dosing chambers 6, wherein each dosing chamber is configured to temporarily contain a minimum metered amount of the substance, wherein each of said dosing chambers takes an release state when the outlet aperture is open, and a fill state when the outlet aperture is sealed, wherein the dosing chamber alters between its release state and its fill state during the rotation of the metering disc, and wherein the rotational movement in at least one rotational direction of the metering disc is actuated by the actuator of the dosing mechanism through a central rotatable axis.

In order to define the metered amount of the substance to be dispensed, the dose selector 4 of the dosing mechanism is angularly displaced from a first set position into another set position.

In order to actuate the release of the defined metered amount the rotatable actuator 3 is rotated into its maximum angular displacement position defined by the set position taken by the dose selector 4, thereby rotating the metering disc 65, such that the at least one dosing chamber 6 transitions one or more times from its fill state, in which the dosing chamber is filled with a minimum metered amount of the substance, to its release state, in which the minimum metered amount is dispensed through the outlet aperture of the dosing chamber.

1. A dosing mechanism for providing a metered amount of a powdered or granular substance, comprising
a reservoir for containing a powdered or granular substance,
a rotatable central axis to which a rotatable member for metering a volume of the powdered or granular substance to be dispensed is rotationally fixed,
one or more dosing chambers for temporarily containing a powdered or granular substance, and
an actuator which is connected to the central axis such that the movement of the actuator in at least one rotational or translational direction, which is the actionable direction, actuates the rotation of the central axis in at least one rotational direction,
wherein the at least one dosing chamber can take a fill state in which it is arranged to be filled, and a release state in which it is arranged to release the substance contained in it.

2. The dosing mechanism of claim 1, further comprising a dose selector for defining an amount of the substance to be dispensed.

3. The dosing mechanism of claim 1, wherein the actuator is reversibly mounted on the central axis.

4. The dosing mechanism of claim 1, wherein the actuator is rotatable and wherein the rotational movement of the actuator and the rotational movement of the rotatable member are rotationally coupled through the central axis in at least one actionable rotational direction of the actuator.

5. The dosing mechanism claim 4, wherein the actuator can take a locked position, in which the angular position of the actuator is fixed, and wherein the actuator can take an open position, in which the actuator can perform a rotational movement.

6. The dosing mechanism of claim 1, wherein the rotatable member is a metering disc comprising the one or more dosing chambers, and wherein the fill state and the release state of the one or more dosing chambers is defined by the angular position of the metering disc.

7. The dosing mechanism of claim 4, wherein the dose selector is configured to define a maximum angular displacement position of the rotatable actuator in the actuator's actionable rotational direction.

8. The dosing mechanism of claim 4, wherein the dose selector is configured to be moved into a set position in which the dose selector is angularly fixed relative to the reservoir, and wherein the set position taken by the dose selector defines a maximum angular displacement position of the rotatable actuator in its actionable direction.

9. The dosing mechanism of claim 5, wherein the dose selector is only angularly displaceable relative to the reservoir when the actuator is in its locked position.

10. The dosing mechanism of claim 2, wherein the dose selector comprises an annular portion, which is at least partially arranged around a cylindrical portion of the reservoir.

11. The dosing mechanism of claim 5, wherein the rotatable actuator takes its open position when it is disposed in a proximal position, in which the rotatable actuator is close to the reservoir and/or the dose selector, or in which it is abutting the reservoir and/or the dose selector, and wherein the rotatable actuator takes its locked position when it is disposed in a distal position away from the reservoir and/or the dose selector.

12. The dosing mechanism of claim 2, wherein the dose selector can take a plurality of regularly spaced set positions.

13. The dosing mechanism of claim 4, wherein the angular displacement of the dose selector between two adjacent set positions defines a minimum metered amount of the powdered or granular substance to be dispensed.

14. A dispensing mechanism for providing metered amounts of a powdered or granular substance, comprising
a reservoir for containing the powdered or granular substance with one or multiple dosage openings for releasing the contained powdered or granular substance,
a rotatable metering disc comprising one or more dosing chambers for temporarily containing a powdered or granular substance, each dosing chamber having an inlet aperture for receiving the powdered or granular substance when aligned with the dosage opening of the reservoir, and an outlet aperture for releasing the received powdered or granular substance,
a central rotatable axis onto which the metering disc is rotationally fixed,
wherein the one or more dosing chambers can take a fill state in which the inlet aperture and the dosage opening of the reservoir are superposed to form a joint opening and in which the outlet aperture is sealed, and wherein the one or more dosing chambers can take a release state in which the inlet aperture and the dosage opening are not superposed and in which the outlet aperture is open,
wherein the state of the dosing chamber is defined by its angular position, and
wherein the rotational movement of the central axis actuates the angular displacement of the metering disc.

15. The dispensing mechanism of claim 14, the metering disc comprising radial sectors, which are preferably equally dimensioned, wherein a sector comprising a dosing chamber alternates with a solid sector without a dosing chamber.

16. The dispensing mechanism of claim 14, or further comprising a controlled release member having a planar portion for covering the outlet aperture of one or more dosing chambers, and one or multiple release apertures adapted for releasing the substance temporarily contained in the dosing chamber when the outlet aperture and the release aperture are superposed to form a joint opening, such that the dosing chamber takes its release state.

17. The dispensing mechanism of claim 14, further comprising a guiding member for directing the powdered or granular substance contained in the reservoir to the dosage opening of the reservoir, said guiding member being either fixed to the reservoir, such as a guiding inner wall or a funnel, or being rotationally fixed to the central axis, such as rotatable guiding blades.

18. The dispensing mechanism of claim 14, wherein each of the plurality of dosing chambers has the same volume, said volume defining the minimum metered amount of the substance to be dispensed, and wherein the metered amount of the substance which is dispensed is a multiple of the minimum metered amount.

19. A device for dosing and dispensing metered amounts of a powdered or granular substance, comprising
the dosing mechanism of claim 1, and
a dispensing mechanism comprising a rotatable metering disc with one or more dosing chambers each provided with an outlet aperture, wherein the one or more dosing chambers are configured to temporarily contain a defined amount of the substance, and wherein the one or more dosing chambers are configured to alternate between a fill state in which the outlet aperture is sealed, and a release state in which the outlet aperture is open.

20. The device of claim 19, wherein the rotatable central axis of the dispensing mechanism extends axially through the reservoir, wherein the rotatable metering disc is mounted about one end portion or attached to one end of the central rotatable axis in a rotationally fixed manner, and wherein the actuator of the dosing mechanism is disposed on the opposite end portion or disposed on the opposite end of the rotatable central axis, such that the actuator actuates the rotational movement of the central axis and the metering disc when the actuator performs a movement in its actionable direction.

21. A method for providing a metered amount of a powdered or granular substance, comprising the following steps,
providing the powdered or granular substance in a dosing device comprising the dosing mechanism of claim 1, a metering disc comprising at least one, preferably a plurality of dosing chambers with a reversibly sealable outlet aperture, wherein each of the dosing chamber is configured to temporarily contain a minimum metered amount of the substance, wherein each of the dosing chambers takes a release state when the outlet aperture is open, and a fill state when the outlet aperture is sealed, wherein the dosing chamber alters between its release state and its fill state during the rotation of the metering disc, and wherein the rotational movement in at least one rotational direction of the metering disc is actuated by the actuator of the dosing mechanism through a central rotatable axis,
moving the dose selector of the dosing mechanism from a first set position to a set position, thereby defining a metered amount to be dispensed, the metered amount being a multiple of the minimum metered amount,
moving the actuator into its maximum displacement position defined by the set position taken by the dose selector, thereby rotating the metering disc, such that the at least one the dosing chamber transitions one or more times from its fill state, in which the dosing chamber is filled with a minimum metered amount of the substance, to its release state, in which the minimum metered amount is dispensed through the outlet aperture of the dosing chamber.
